(19) United States
(12) Patent Application Publication
(10) Pub. No.: US 2010/0211389 A1
(43) Pub. Date: Aug. 19, 2010

(54) System of communication employing both voice and text

(76) Inventor: Kyle Robert Marquardt, Naperville, IL (US)

Correspondence Address: Kyle R. Marquardt, 33 Pottowattomie Ct., Naperville, IL, 60563, US

(21) Appl. No.: 12/378,270

(22) Filed: Feb. 13, 2009

(51) Int. Cl. G10L 15/26; G10L 13/00

(52) U.S. Cl. 704/235; 704/260; 704/E13.001; 704/E15.043

(57) ABSTRACT

The disclosed invention comprises a method of communication that integrates both speech to text technology and text to speech technology. In its simplest form, one user employs a communication device having means for converting vocal signals into text; this converted text is then sent to the other user. This recipient is presented with the sender's text and to respond, he can enter text which is then output to the first user as speech sounds. This system creates an opportunity for two users to carry on a conversation, one using his voice (and hearing a synthesized voice in response) and the other using text (and receiving speech rendered as text): the first user has a voice conversation; the second user has a text based conversation. This system allows a user to select his preferred method of communication, regardless of the selection of his communication partner.

Referenced patents (listed in the Information Disclosure Statement)

U.S. Pat. No. 4,996,707

U.S. Pat. No. 6.293.584

U.S. Pat. No. 5,457,738

U.S. Pat. No. 5,724,410

U.S. Pat. No. 5,857,099

U.S. Pat. No. 6.138,096

U.S. Pat. No. 6,173,250

U.S. Pat. No. 6,173,259

U.S. Pat. No. 6,385,586

U.S. Pat. No. 6,463,078

U.S. Pat. No. 6,549,937

U.S. Pat. No. 6,976,082

U.S. Pat. No. 7,119,918

U.S. Pat. No. 7,185,059

U.S. Pat. No. 7,359,492

### BACKGROUND OF THE INVENTION

The disclosed invention relates to a system of electronic communication. Various methods of communication employ text-based signal transmission, such as text messaging, web chat, email and various other technologies. However, one wishing to use a text-based system does not have the ability to communicate with those wishing to carry on a voice conversation. Various inventions have been created that allow for the conversion of text into speech and speech into text, but these technologies have never been integrated to create a system capable of enabling conversation between users of voice and text protocols. The present invention discloses a method detailing this system.

### BRIEF SUMMARY OF THE INVENTION

The disclosed invention comprises a method of communication that integrates both speech to text technology and text to speech technology. In its simplest form, one user employs a communication device having means for converting vocal signals into text; this converted text is then sent to the other user. This recipient is presented with the sender's text and to respond, he can enter text which is then output to the first user as speech sounds. This system creates an opportunity for two users to carry on a conversation, one using his voice (and hearing a synthesized voice in response) and the other using text (and receiving speech rendered as text): the first user has a voice conversation; the second user has a text based conversation. This system allows a user to select his preferred method of communication, regardless of the selection of his communication partner.

### BRIEF DESCRIPTION OF THE DRAWINGS

FIG. 1 illustrates the disclosed communication system which allows one user to have a voice-based conversation and his conversation partner to have a text-based conversation.

FIG. 2 illustrates the process of using past speech to text activity to augment the synthesized speech that the same user converts from text.

### DETAILED DESCRIPTION OF THE INVENTION

The preferred embodiment of this invention employs electronic communication devices, such as computers, telephones, cellular phones, personal digital assistants and others. These devices communicate across a network (including, but not limited to, the internet, wireless networks, local area networks, satellite networks, and others) and each device processes the input signals before they are output. The system allows two or more users to communicate using different types of data.

The communication system necessitates at least two communication devices, but is capable of integrating a plurality of devices into the communication network. In the preferred embodiment, both devices have the ability to convert text to speech and speech to text; however, this is not necessary if the user chooses to only convert one type of data. Between these two devices, a communication link is established, allowing for the transfer of communication data between devices. When a communication link is established between these devices, the devices have means for recognizing the type of data the user wishes to receive. For instance, for a user who is translating his voice into text, his device will convey that he wishes to receive communication data in the form of speech. In the case that the two users wish to communicate using different data types, the devices create a communication channel whereby each user translates his data input into a medium useful to the recipient before sending.

The system could operate like an open communication channel or like a messaging system. For instance, a user's vocal input could be translated and sent word by word to the recipient. When the recipient responds by entering text, when each word is entered, it is immediately processed and sent to the first sender. If it were to operate as a messaging system, the user inputting vocal data would complete his statement or message and then indicate that he wishes to translate the entered message and then send the text to the second user. In the same way, the user who inputs text would complete his statement before commanding that the entered data be translated into speech sounds and sent. Of course, a combination of these two methods could also be employed.

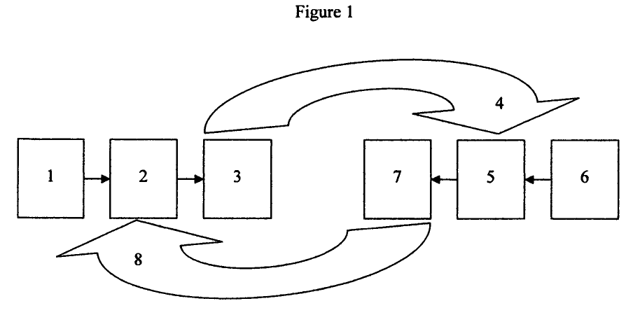

FIG. 1 demonstrates the process involved in the general two-way communication. The first user's input vocal signals are denoted by object (1). The signals (1) are input into the first communication device having means for converting vocal signals into text; the device is denoted by object (2). The voice signals converted into text are denoted by object (3). When the text signals are transmitted (4), they are received by the second communication device (5). This device also receives the input text signals, intended for transmission (6), and then converts it into synthesized speech (7). The speech is then transmitted to the first device (8), creating a cycle of communication between the devices, based on different input, but receiving signals that are of the same type as the inputs. The following list labels the parts of FIG. 1.
1. Vocal signals input into first communication device
2. Communication device having means for converting vocal signals into text
3. Text form of vocal signals
4. Text signal transmission
5. Communication device which receives text signal transmission and also converts input text signals into synthesized speech
6. Input text signals for second communication device
7. Output synthesized speech
8. Synthesized speech transmission

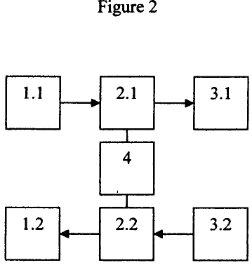

In order to increase the realism of the synthesized speech, a method can also be integrated into this system which enriches a user's output synthesized speech using previously input, and translated into text, real speech. FIG. 2 shows a method of doing this. In the preferred embodiment, both devices will have the capability of performing both functions (converting vocal signals to text and converting text to vocal signals). In order to improve the realism of the user's output synthesized voice, the activity from a user's speaking conversations (that are converted into text) is stored and used to modify the user's synthesized voice. For instance if a user says “meet me at school,” the speech is processed through the device (2.1) and output as text (3.1). This speech processing is recorded for future use (4). When a user intends to have his text converted into speech, the recorded activity stored in (4) is used to modify the synthesized voice. Through this system, if the same user, in a later text conversation, converts the text “I'm at school,” the system will be able to augment the synthesized voice for at least the words “at” and “school” creating the effect as if the user actually spoke the words, rather than converted them from text. After extensive usage, a vocal library (4) can be created to make a user's synthesized voice realistic. In order to better improve this system, the user's words can be broken down into smaller parts, such as phonemes, allowing for the output of a more diverse set of words, many of which may have never been spoken. So when a user enters text (3.2) into the device ((2.2), same device as (2.1), but acting as a text-to-speech converter) the output speech (1.1) is augmented by the stored activity (4).

I claim:

1. An apparatus for multi-directional communication comprising:
An electronic communication device having means for converting a vocal signal into text and,
A second electronic communication device having means for converting text into speech.

2. An apparatus for multi-directional communication as in claim 1, also comprising means for augmenting said output speech to more closely resemble the sender's voice.

3. An apparatus for multi-directional communication as in claim 2, also comprising means for using past speech to text activity of a user to augment said output speech.

4. An apparatus for multi-directional communication as in claim 3, also comprising a system for storing said past speech to text activity.

5. A method of multi-directional communication comprising:
An electronic communication device transmitting a text signal, converted from a vocal signal and,
An electronic communication device transmitting a speech signal, converted from a text signal.

6. A method of multi-directional communication as in claim 5, also comprising means for augmenting said output speech to more closely resemble the sender's voice.

7. A method of multi-directional communication as in claim 6, also comprising means for using past speech to text activity of a user to augment said output speech.

8. A method of multi-directional communication as in claim 7, also comprising a system for storing said past speech to text activity.

9. A computer-readable medium having stored thereon computer-executable instructions for establishing a system of multi-directional communication comprising:
An electronic communication device transmitting a text signal, converted from a vocal signal and,
An electronic communication device transmitting a speech signal, converted from a text signal.

10. A computer-readable medium having stored thereon computer-executable instructions for establishing a system of multi-directional communication as in claim 9, also comprising means for augmenting said output speech to more closely resemble the sender's voice.
